(19) United States
(12) Patent Application Publication
(10) Pub. No.: US 2026/0278557 A1
(43) Pub. Date: Sep. 17, 2026

(54) MANAGEMENT SYSTEM

(71) Applicant: SAKURA RUBBER CO., LTD., Tokyo (JP)

(72) Inventors: Tetsuya Iwasaki, Tokyo (JP); Yutaka Abe, Tokyo (JP)

(73) Assignee: SAKURA RUBBER CO., LTD., Tokyo (JP)

(21) Appl. No.: 19/679,047

(22) Filed: May 15, 2026

Related U.S. Application Data
(63) Continuation of application No. PCT/JP2024/039850, filed on Nov. 8, 2024.

(30) Foreign Application Priority Data
Nov. 16, 2023 (JP) 2023-195219

(51) Int. Cl. G06Q 10/109; B66B 1/34

(52) U.S. Cl. CPC G06Q 10/109; B66B 1/34

(57) ABSTRACT

According to one embodiment, a management system manages a waiting space for holding an object transported by the elevator. The management system includes a first acquisition unit for acquiring object information relating to the object, and a first reservation unit for reserving the waiting space for holding the object indicated by the object information based on congestion information of the elevator.

### CROSS-REFERENCE TO RELATED APPLICATIONS

This application is a Continuation Application of PCT Application No. PCT/JP2024/039850, filed Nov. 8, 2024 and based upon and claiming the benefit of priority from prior Japanese Patent Application No. 2023-195219, filed Nov. 16, 2023, the entire contents of all of which are incorporated herein by reference.

### BACKGROUND OF THE INVENTION

### 1. Field of the Invention

The present invention relates to a management system.

### 2. Description of the Related Art

A building such as a high-rise building may include a plurality of elevators for respective uses, such as an elevator dedicated to general users, an elevator dedicated to Very Important Persons (VIPs), and an elevator dedicated to cargo handling. Various proposals have also been made for elevators, including an elevator including a plurality of cars, for purposes such as improving elevator transport capacity (for example, JP 5477387 B).

Even in view of the double-deck elevator group management apparatus disclosed in JP 5477387 B, various problems remain in a building in which elevators are installed. An elevator extends through many floors. Thus, the ratio of the elevators to the total floor area of the building is large. An increase in the number of elevators increases the burden on the overall building planning and greatly restricts the degree of freedom in floor planning on each floor.

Further, one possible trend involves an increase in cargo-handling demand due to more frequent delivery to tenants and mixed use with restaurant tenants. Thus, a reduction in the number of elevators is required in order to reduce the burden of elevators on the total floor area of the building and increase the degree of freedom in floor planning on each floor. At the same time, improvement in convenience for cargo handling and transportation in an environment suitable for each transported object are also required.

One object of the present invention is to provide a management system capable of improving convenience for users of a building.

### BRIEF SUMMARY OF THE INVENTION

According to an embodiment, a management system manages a waiting space for holding an object transported by the elevator. The management system includes a first acquisition unit for acquiring object information relating to the object, and a first reservation unit for reserving the waiting space for holding the object indicated by the object information based on congestion information of the elevator.

The management system may further include a second reservation unit for reserving the elevator that transports the object indicated by the object information based on the congestion information, and an elevator control unit for controlling the elevator based on reservation information for the elevator reserved by the second reservation unit.

The management system may further include a third reservation unit for reserving a first vehicle that transports the object based on reservation information of the waiting space reserved by the first reservation unit. The management system may further include a second acquisition unit for acquiring arrival information of the first vehicle reserved by the third reservation unit. The elevator control unit may control the elevator based on the arrival information.

The elevator may include an upper car and a lower car coupled to the upper car. The lower car may transport the object different from the object transported by the upper car. The elevator may be configured such that at least one of the upper car and the lower car is replaceable. The elevator control unit may replace the upper car or the lower car based on reservation information for the elevator and the object information.

The first reservation unit may identify a reservable time for the waiting space based on the congestion information and output the reservable time to a user terminal. The management system may further include an adjustment unit for adjusting reservations to collectively transport the plurality of objects based on a plurality of pieces of the object information stored in a database.

The management system may further include a fourth reservation unit for reserving a second vehicle different from the first vehicle based on reservation information of the waiting space reserved by the first reservation unit. The second vehicle may transport the object transported by the first vehicle between the waiting space and an inside of a building where the waiting space is provided.

The management system may further include a transport vehicle control unit for controlling the second vehicle based on reservation information of the second vehicle reserved by the fourth reservation unit. The second vehicle may transport the object transported by the first vehicle between the waiting space and a building different from the building.

The management system may further include a third acquisition unit for acquiring information on surroundings of the second vehicle. The third acquisition unit may output the acquired information on surroundings of the second vehicle to a user terminal.

The object information may include at least one of a quantity, a mass, a type, and a size of the object. The congestion information may include reservation information for the elevator reserved by the second reservation unit.

The congestion information may further include at least one of information relating to a congestion time of the elevator, a calendar, weather, moving, construction work, and an event. Reservation information of the waiting space may include at least one of identification information for identifying the waiting space and a reserved time of the waiting space reserved.

The reservation information for the elevator may include at least one of identification information for identifying a car included in the elevator, a type of a car included in the elevator, and a reserved time of the elevator. The object may be at least one of cargo and a VIP.

The present invention can provide a management system capable of improving convenience for users of a building.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing a configuration example of a management system according to the first embodiment.

FIG. 2 is a schematic perspective view of the elevator shown in FIG. 1.

FIG. 3 is a diagram showing an example of reservation information stored in a first database.

FIG. 4 is a diagram showing an example of information stored in a second database.

FIG. 5 is a flowchart showing an example of processing in the management system according to the first embodiment.

FIG. 6 is a flowchart showing an example of processing in the management system according to the first embodiment.

FIG. 7 is a diagram showing an example of a display unit of a user terminal.

FIG. 8 is a diagram showing a configuration example of a management system according to the second embodiment.

FIG. 9 is a flowchart showing an example of processing in the management system according to the second embodiment.

FIG. 10 is a flowchart showing an example of processing in the management system according to the second embodiment.

FIG. 11 is a diagram showing a configuration example of a management system according to the third embodiment.

FIG. 12 is a schematic perspective view of the elevator shown in FIG. 11.

### DETAILED DESCRIPTION OF THE INVENTION

Embodiments of the present invention will hereinafter be described with reference to the drawings.

A management system according to each embodiment manages an elevator, a waiting space for holding an object transported by the elevator, and a vehicle that transports the object. That is, the elevator, the waiting space, and the vehicle are managed in an integrated manner by the management system.

### First Embodiment

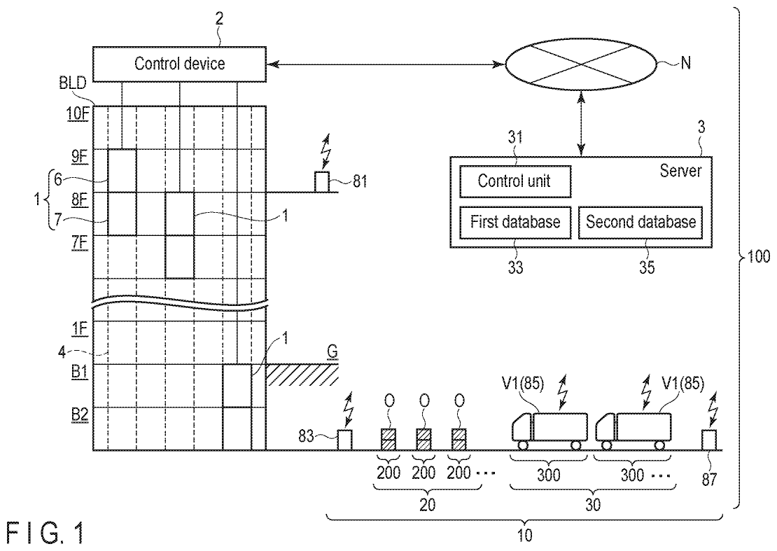

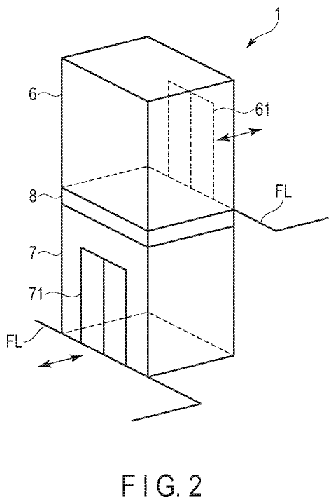

FIG. 1 is a diagram showing a configuration example of a management system 100 according to the present embodiment. FIG. 2 is a schematic perspective view of an elevator 1 shown in FIG. 1. The management system 100 comprises a control device 2 configured to control operation of the elevator 1 and a server 3. The control device 2 and the server 3 are communicably connected to each other through the network N.

First, the following will describe a building BLD in which the elevator 1 is installed.

The building BLD is, for example, a commercial facility. The building BLD has above-ground floors 1F to 10F. located above a ground G and basement floors B1 and B2 located below the ground G. These examples do not limit the above-ground floors 1F to 10F and the basement floors B1 and B2 included in the building BLD.

Among the floors, a floor occupied by a hotel is sometimes referred to as a hotel floor, a floor occupied by a restaurant is sometimes referred to as a restaurant floor, a floor occupied by an office is sometimes referred to as an office floor, and a floor occupied by a museum, an art museum, or the like is sometimes referred to as an exhibition floor. A hotel, restaurant, office, museum, art museum, or the like occupying the building is sometimes collectively referred to as a tenant. Different types of tenants (for example an office and an art museum) may occupy the same floor. The following will omit explanations on such cases.

The building BLD includes various floors such as office floors, restaurant floors, and hotel floors. The restaurant floors and hotel floors are provided, for example, on floors higher than the office floors.

In the example shown in FIG. 1, a cargo handling space 10 is provided on the basement floor B2 of the building BLD. This example does not limit the location of the cargo handling space 10. The cargo handling space 10 is an example of the waiting space. For example, a manager may stay in the cargo handling space 10.

For example, the cargo handling space 10 is a space for cargo handling in the building BLD. Alternatively, the cargo handling space 10 may be a space for cargo handling in a plurality of buildings including the building BLD and buildings near the building BLD. In this case, the cargo handling space 10 serves as a shared cargo handling space for an area near and including the building BLD.

Cargo handling refers to transport of cargo (shown as cargo 0 in FIG. 1) and work accompanying the transport. Cargo transport includes loading and unloading cargo. Loading cargo corresponds to movement of cargo from outside the building BLD to inside the building BLD, and unloading cargo corresponds to movement of cargo from inside the building BLD to outside the building BLD.

For example, a vehicle V1 for transporting cargo transports the cargo through the cargo handling space 10. In the present embodiment, the vehicle V1 corresponds to an example of the first vehicle. For example, the vehicle V1 is a truck, a garbage truck, or the like having a cargo compartment for loading cargo. The vehicle V1 may be a refrigerator truck, a freezer truck, or the like depending on characteristics of the cargo. For example, the vehicle V1 is driven by a driver. Alternatively, the vehicle V1 may be an autonomous vehicle.

Autonomous vehicles include an autonomous vehicle capable of fully autonomous driving that requires no human operation and can travel automatically, and an autonomous vehicle capable of partial autonomous driving that can travel automatically under a specific environment and can switch to human driving. Thus, the vehicle V1 entering or leaving the cargo handling space 10 may have no driver on board.

The cargo handling space 10 includes a cargo space 20 and a parking space 30. The cargo space 20 is a space for holding cargo. The parking space 30 allows parking of the vehicle V1 for transporting cargo. The parking space 30 may include a work space for a driver, a forklift, or the like to load and unload cargo to and from the vehicle V1.

For example, the cargo space 20 and the parking space 30 respectively include a plurality of sections 200 and 300. Each section 200 of the cargo space 20 has a cargo space number, which is identification information for identifying the section. At least one piece of cargo can be held in one section 200. Each section 300 of the parking space 30 has a parking space number, which is identification information for identifying the section.

The waiting time of cargo in the section 200 of the cargo space 20 is appropriately changed according to the type of cargo or the like. The cargo may be held in the section 200 for a certain period for the elevator 1 or the vehicle V1 to collectively transport (collectively deliver) the cargo. The section 200 of the cargo space 20 may include a section dedicated to waste. In this case, the section may have a function of refrigerating the waste to prevent deterioration of the waste and generation of malodor.

The building BLD comprises at least one elevator 1. In the example shown in FIG. 1, the building BLD comprises a plurality of elevators 1, for example three elevators. In one example, the plurality of elevators 1 are respectively installed in elevator shafts 4 extending through the floors, for example, from the basement floor B2 to the above-ground floor 10F.

In another example, the plurality of elevators 1 may be installed in one elevator shaft 4 as one group of elevators. Specifically, in a high-rise building, elevators for lower floors, middle floors, and upper floors may form one elevator group, and that elevator group may be installed in one elevator shaft 4.

The elevator shafts 4 are provided as appropriate according to the number of elevators 1 to be installed. The plurality of elevators 1 allow passengers to get on and off on all of the above-ground floors 1F to 10F and the basement floors B1 and B2. The plurality of elevators 1 may instead allow passengers to get on and off only on specific floors, for example upper floors and the basement floors B1 and B2.

As shown in FIG. 1 and FIG. 2, the elevator 1 comprises an upper car 6, a lower car 7, and a coupling mechanism 8 configured to couple the upper car 6 and the lower car 7. The coupling mechanism 8 may adopt various mechanisms.

The elevator 1 stops the upper car 6 and the lower car 7 on different floors. For example, when the upper car 6 stops on the above-ground floor 8F, the lower car 7 stops on the above-ground floor 7F. Each of the upper car 6 and the lower car 7 has a car number, which is identification information for identifying the car.

As shown in FIG. 2, the upper car 6 and the lower car 7 respectively have doors 61 and 71. For example, the door 61 of the upper car 6 and the door 71 of the lower car 7 are provided such that entrance positions on each floor differ from each other.

Thus, in the elevator 1, a boarding/alighting place FL for the upper car 6 and a boarding/alighting place FL for the lower car 7 are separated. In the example shown in FIG. 2, the door 61 of the upper car 6 is provided at the position opposite to the door 71 of the lower car 7. This example does not limit the configuration.

Users of the building BLD include visitors to the building BLD, such as general users, special users such as VIPs, employees of tenants, and pickup and delivery personnel who collect and deliver cargo (for example a driver of the vehicle V1).

The present embodiment assumes a case where the upper car 6 transports general users and the lower car 7 transports cargo. A general user corresponds to an example of an object that the upper car 6 of the elevator 1 transports. Cargo corresponds to an example of an object that the lower car 7 of the elevator 1 transports. In the present embodiment, the elevator 1 transports different objects in the upper car 6 and the lower car 7.

During cargo transportation, a person transporting the cargo (such as a tenant employee or the driver of the vehicle V1) may ride in the lower car 7. Cargo may be present in the lower car 7 while general users ride in the upper car 6.

The cargo includes objects transported regularly, objects transported only at a specific timing, and objects requiring special care during transport. The cargo is not limited to these examples and also includes general objects transported by the elevator 1.

Objects transported regularly include, for example, laundry, bedding, food ingredients, beverages, waste such as garbage and bottles on hotel floors and restaurant floors and office supplies, reference materials, and documents, parcels, and the like represented by postal matter on office floors.

Examples of objects transported only at a specific timing include objects related to tenant relocation, company exhibits and printed matter prepared for an exhibition, construction materials and tools on a floor under construction, and waste materials. The timing may be a specific day or may be a specific time period.

Objects requiring special care during transport include, for example, exhibits on exhibition floors such as museums and art museums, ice sculptures or musical instruments for events.

As described above, the boarding/alighting place FL for the upper car 6 and the boarding/alighting place FL for the lower car 7 are separated. This configuration allows general users to avoid waiting for the elevator 1 at the same boarding/alighting place FL as cargo or a person transporting cargo.

When the building BLD includes a plurality of elevators 1, the object transported by the lower car 7 may be determined in advance. For example, among the plurality of elevators 1, one lower car 7 may have a VIP as its object, and the remaining lower cars 7 may have cargo as their object. The door 71 of the lower car 7 may be provided such that entrance positions on each floor differ from each other depending on the object.

The control device 2 controls operation of the plurality of elevators 1. For example, the control device 2 controls a lifting and lowering drive device (a hoisting machine) for raising and lowering the upper car 6 and the lower car 7, and an opening/closing device for opening and closing the doors. The lifting and lowering drive device and the opening/closing device are not shown.

The control device 2 is constituted by a computer including a processor such as a CPU, a storage device such as a ROM and a RAM, and an interface with the outside. The control device 2 achieves various processes by causing the processor to execute a computer program stored in the storage device.

In one example, the control device 2 is provided for each of the plurality of elevators 1. In this case, the control devices 2 of the plurality of elevators 1 operate in coordination with each other. In another example, one control device 2 is provided for the plurality of elevators 1. The control device 2 transmits information relating to the positions of the elevators 1 or the like to the server 3. These pieces of information are continuously updated at appropriate time intervals to maintain the latest state.

The server 3 is constituted by a computer including a processor such as a CPU, a storage device such as a ROM and a RAM, and an interface with the outside. The server 3 may be provided inside the building BLD or may be provided outside the building BLD. The server 3 may be a server included in a cloud system.

The server 3 includes a control unit 31, a first database 33, and a second database 35. For example, the control unit 31 is achieved by the processor executing a computer program stored in the storage device.

In the server 3, a storage device (not shown) stores information relating to the elevator 1, information relating to the cargo space 20, information relating to the parking space 30, and information relating to the vehicle V1. The information relating to the elevator 1 includes the number of elevators 1, the car numbers, and the like.

The information relating to the cargo space 20 includes the number of sections 200 in the cargo space 20, the cargo space numbers, sizes of the sections 200 (for example depth and width), the quantity of cargo that can be held in each section 200, the total mass of cargo that can be held in each section 200, and the like. The information relating to the parking space 30 includes the number of sections 300 in the parking space 30, the parking space numbers, sizes of the sections 300 (for example depth, width, and height), types of vehicles V1 that can be parked, whether equipment for charging the vehicle V1 is provided in the sections 300, and the like. The information relating to the vehicle V1 includes the number of vehicles V1, sizes of the vehicles V1, functions included in the vehicles V1, and the like.

The first database 33 and the second database 35 may be stored in storage devices different from that of the server 3. In the present embodiment, information stored in the first database 33 and the second database 35 corresponds to congestion information of the elevator 1, the cargo handling space 10, and the vehicle V1. The congestion information is used for managing or predicting congestion of the elevator 1, the cargo handling space 10, and the vehicle V1.

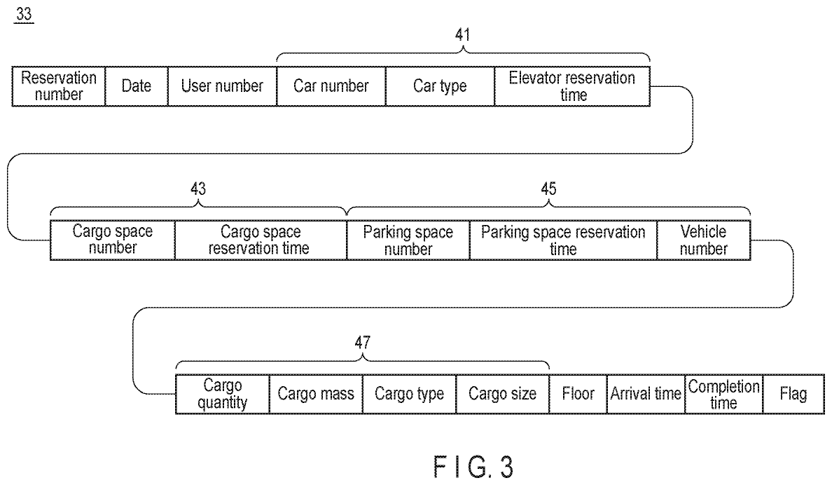

The first database 33 stores reservation information reserved by the control unit 31 of the management system 100. FIG. 3 is a diagram showing an example of reservation information stored in the first database 33. FIG. 3 shows one row of data (one record) among a plurality of pieces of reservation information (table).

The reservation information includes a reservation number, which is identification information for identifying each reservation, date information indicating a reservation date, a user number, which is identification information for identifying the user who made the reservation, reservation information 41 of the elevator 1, reservation information 43 of the cargo space 20, reservation information 45 of the parking space 30, cargo information 47, a floor to which the cargo is transported, an arrival time at which the vehicle V1 arrived at the parking space 30, a completion time at which cargo handling was completed, a flag indicating completion of cargo handling, and so on. The cargo information 47 corresponds to an example of object information.

The reservation information 43 of the cargo space 20 and the reservation information 45 of the parking space 30 are hereinafter sometimes collectively referred to as reservation information of the cargo handling space 10. The reservation information described above is associated with an assigned reservation number and stored in the first database 33.

For example, the date information is a reservation date (for example, year, month, and day). The reservation information 41 of the elevator 1 includes a car number, a car type, and a reserved time of the elevator 1. Hereinafter, a time reserved by the management system 100 has a predetermined duration. The duration may be, for example, in units of one minute, five minutes, ten minutes, fifteen minutes, twenty minutes, thirty minutes, or one hour. These examples do not limit the duration. The duration may be predetermined according to a tendency of cargo that varies depending on the type of cargo, the type of work, the use of the building BLD, the type of tenants occupying the building, and the like.

The reservation information 43 of the cargo space 20 includes a cargo space number and a reserved time of the cargo space 20. The reservation information 45 of the parking space 30 includes a parking space number, a reserved time of the parking space 30, and a vehicle number, which is identification information for identifying the reserved vehicle V1.

The cargo information 47 includes a quantity of cargo, a mass of cargo, a type of cargo, and a cargo size. The type of cargo includes, for example, the objects transported regularly, the objects transported only at a specific timing, and the objects requiring special care during transport described above. The included information is not limited to these examples.

The second database 35 stores information different from the reservation information.

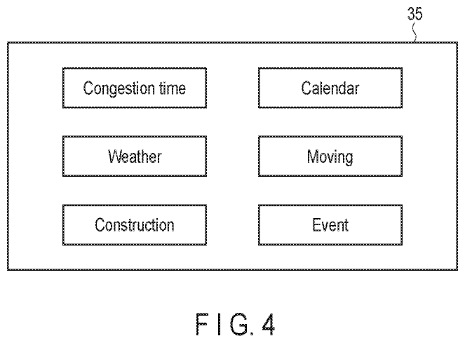

Information stored in the second database 35 relates to factors that affect cargo handling. FIG. 4 shows an example of information stored in the second database 35.

The second database 35 includes information relating to a congestion time of each elevator 1, a calendar, weather, moving of tenants, construction work in the building BLD, events held in or near the building BLD (for example a local festival and traffic restrictions near the building BLD associated with the festival), and the like.

The information relating to congestion time includes information relating to a peak usage time of the elevator 1. The peak usage time of the elevator 1 includes commuting times for general users going to and leaving office floors, peak delivery times to tenants, and a time immediately before a large meeting starts during which an ascending elevator is used. The information relating to the calendar includes a year, a month, a day, a day of the week, public holidays, tenant closure days, and the like.

The information relating to weather includes, for example, a daily weather forecast. The information relating to moving includes a moving date associated with tenant move-in or move-out, a moving time, a required moving time, and a floor on which moving occurs. The information relating to an event includes an event type and an event time. The second database 35 may further include other information.

The management system 100 updates the first database 33 and the second database 35 as appropriate. The first database 33 is updated, for example, when reservation processing and work completion processing are performed in the management system 100.

The various types of information stored in the second database 35 may be updated at predetermined timings, may be updated in real time, or may be updated as appropriate in response to acquisition of information from various terminals (for example a user terminal described later).

As shown in FIG. 1, the management system 100 may further comprise a tenant terminal 81. The tenant terminal 81 is communicably connected to the server 3 through a network N. For example, at least one tenant terminal 81 is provided for each tenant on each floor.

For example, the tenant terminal 81 is a portable tablet terminal. FIG. 1 shows the tenant terminal 81 installed for a tenant on the above-ground floor 9F. For example, the tenant terminal 81 is operated by an employee of the tenant.

As shown in FIG. 1, the management system 100 may further comprise a cargo handling space terminal 83. The cargo handling space terminal 83 is communicably connected to the server 3 through the network N.

At least one cargo handling space terminal 83 is provided, for example, in the cargo handling space 10. For example, the cargo handling space terminal 83 is a portable tablet terminal. For example, the cargo handling space terminal 83 is operated by a manager of the cargo handling space 10 or a driver of the vehicle V1 to input necessary information, and provide those operators with a status relating to reservations and reservation information of the cargo handling space 10.

As shown in FIG. 1, the management system 100 may further comprise a vehicle terminal 85. The vehicle terminal 85 is communicably connected to the server 3 through the network N. For example, one vehicle terminal 85 is provided in the vehicle V1. For example, the vehicle terminal 85 is operated by the driver of the vehicle V1.

In the present embodiment, the tenant terminal 81, the cargo handling space terminal 83, and the vehicle terminal 85 correspond to examples of user terminals. The tenant terminal 81, the cargo handling space terminal 83, and the vehicle terminal 85 are constituted by computers including, for example, a processor such as a CPU, a storage device such as a ROM and a RAM, and an interface with the outside. The tenant terminal 81, the cargo handling space terminal 83, and the vehicle terminal 85 achieve various processes by causing the processor to execute a computer program stored in the storage device.

In the management system 100, the information stored in the first database 33 and the second database 35 is configured to be viewable through the tenant terminal 81, the cargo handling space terminal 83, the vehicle terminal 85, and the like. The reservation information stored in the first database 33 may be viewable, for example, as a reservation status for each of the elevator 1, the cargo space 20, and the parking space 30.

This configuration allows a tenant employee, the manager of the cargo handling space 10, the driver of the vehicle V1, and the like to confirm, from the reservation information, whether the management in the management system 100 is operating as intended, including vacancy status and congestion status of the elevator 1, the vehicle V1, and the cargo handling space 10, whether the arriving vehicle V1 arrived as scheduled, whether the vehicle V1 departed, and so on.

The management system 100 has the following functions to manage the elevator 1, the cargo handling space 10, and the vehicle V1:
[F1] A function for acquiring cargo information 47 relating to cargo;
[F2] A function of reserving the cargo handling space 10 where the cargo indicated by the cargo information 47 is held based on congestion information;
[F3] A function of reserving the elevator 1 that transports the cargo indicated by the cargo information 47 based on congestion information;
[F4] A function of reserving the vehicle V1 that transports the cargo based on reservation information of the reserved cargo handling space 10;
[F5] A function of acquiring arrival information of the reserved vehicle V1;
[F6] A function of controlling the elevator 1 based on reservation information of the reserved elevator 1; and
[F7] A function of acquiring completion information of cargo handling.

The functions F1 to F7 constitute a reservation system in the management system 100. Objects managed by the management system 100 are not limited to the elevator 1, the cargo handling space 10, and the vehicle V1. The management system 100 may further manage other elements.

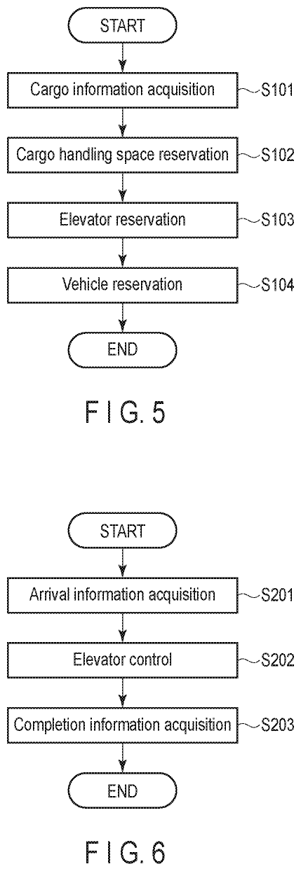

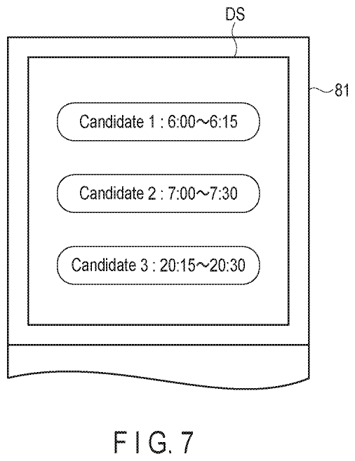

FIG. 5 and FIG. 6 are flowcharts showing an example of processing in the management system 100 according to the present embodiment. FIG. 7 shows an example of a display unit DS of a user terminal.

The following will describe an example in which the functions F1 to F7 in the management system 100 are implemented by the control unit 31 of the server 3 with reference to the flowcharts shown in FIG. 5 and FIG. 6. The following uses a cargo unloading operation from a tenant as an example to explain reservation processing and processing on a date and time for which a reservation has been made.

The following shows an example in which the reservation processing and the processing on a date and time for which a reservation has been made proceed without trouble. A reservation may instead be changed or canceled, or arrival of the vehicle V1 may be delayed. A process affecting such a change in reservation information is performed by interrupting the flowcharts shown in FIG. 5 and FIG. 6 in the middle. This interruption does not change flow of reservation processing. Thus, the following omits a description of that process.

### [Reservation Processing]

An employee of the tenant operates the tenant terminal 81 and inputs the cargo information 47 of cargo to be unloaded. The employee may further input a desired unloading time (for example morning or afternoon). The control unit 31 of the server 3 thereby acquires the cargo information 47 from the tenant terminal 81 (the step S101). The processing in the step S101 corresponds to the function F1.

The control unit 31 reserves the cargo handling space 10 where the cargo indicated by the cargo information 47 is held based on the congestion information (the step S102). Examples of reservation of the cargo handling space 10 include reserving each of the section 200 of the cargo space 20 and the section 300 of the parking space 30. The processing in the step S102 corresponds to the function F2.

In the step S102, the control unit 31 acquires the cargo information 47 and then identifies a reservable section 200 of the cargo space 20 based on the congestion information.

The control unit 31 outputs a reservable time of the identified section 200 to the tenant terminal 81. For example, the tenant terminal 81 acquires the information and displays the identified reservable time of the section 200 on the display unit DS. FIG. 7 shows three reservable times on the display unit DS (for example a display). Widths of the displayed times may differ from each other or may be the same. The user terminal corresponds here to the tenant terminal 81.

When a plurality of reservable times exist, the employee selects one desired time from the plurality of times. After the employee selects the desired time, the control unit 31 acquires information of the selected time from the tenant terminal 81. In this manner, the control unit 31 thereby reserves the section 200 of the cargo space 20 where cargo is held at the selected time.

Next, based on the time at which the section 200 of the cargo space 20 has been reserved, the control unit 31 identifies and reserves a reservable section 300 of the parking space 30. The section 200 of the cargo space 20 and the section 300 of the parking space 30 are thereby determined. The processing of the step S102 by the control unit 31 is thus completed.

The following will describe an example in which the control unit 31 identifies the section 200 of the cargo space 20 and the section 300 of the parking space 30 based on the congestion information.

The control unit 31 identifies the section 200 of the cargo space 20 and a reservable time based, for example, on the congestion information of the elevator 1. Specifically, the control unit 31 extracts the car number included in the reservation information 41 of the elevator 1 and an elevator reservation time of the elevator 1 having that car stored in the first database 33. The control unit 31 thereby identifies the lower car 7 of the elevator 1 for which no reservation exists and a reservable time.

Further, the control unit 31 determines whether the section 200 of the cargo space 20 is vacant based on the identified time.

For example, the control unit 31 determines whether the section 200 of the cargo space 20 is vacant by extracting the cargo space number included in the reservation information 43 of the cargo space 20 and a cargo space reservation time of the cargo space 20 stored in the first database 33.

A time determined to be vacant is a time that avoids congestion of the elevator 1 and can be a candidate reservable time for the section 200 of the cargo space 20. That is, this time is a time at which cargo can be transported by the elevator 1. This configuration allows a time that avoids a congested time to be notified to a user through the tenant terminal 81. The identified time is at least one time and may be two or more times.

Among times during which the identified section 200 of the cargo space 20 has no reservation, the control unit 31 may further identify candidates of times to be output to the tenant terminal 81 based on information relating to factors affecting cargo handling stored in the second database 35.

For example, the control unit 31 extracts a peak time of general users included in the congestion information, a moving time included in information relating to moving, and an event time included in information relating to an event stored in the second database 35.

When an identified non-reserved time of the section 200 of the cargo space 20 does not overlap a time extracted from the second database 35, the control unit 31 may output the identified time to the tenant terminal 81. When the identified non-reserved time overlaps the extracted time, the control unit 31 may exclude the identified time from time candidates.

When a plurality of identified time candidates exists, the control unit 31 may further determine priorities for the plurality of time candidates.

The control unit 31 extracts the parking space number of the parking space 30 and a parking space reservation time of the parking space 30 included in the reservation information 45 stored in the first database 33. The control unit 31 thereby identifies and reserves a section 300 of the parking space 30 for which no reservation exists and a reservable time.

For example, the time identified here is a time later than (in the future of) the time at which the cargo space 20 has been reserved. The time at which the section 300 of the parking space 30 is reserved may instead include, for example, the time at which the cargo space 20 has been reserved.

Also in reservation of the section 300 of the parking space 30, the control unit 31 may extract a moving time included in the information relating to moving stored in the second database 35 and an event time included in the information relating to an event.

When the identified non-reserved time of the section 300 of the parking space 30 does not overlap the time extracted from the second database 35, the control unit 31 reserves the section 300 of the parking space 30 at the identified time.

Various methods other than the examples can be used to identify the section 200 of the cargo space 20 and the section 300 of the parking space 30. For example, the control unit 31 may extract other information from each piece of the reservation information stored in the first database 33 and the information stored in the second database 35 and may identify the section 200 of the cargo space 20 and the section 300 of the parking space 30.

Next, the control unit 31 reserves the elevator 1 based on the congestion information of the elevator 1 (the step S103). Reservation of the elevator 1 corresponds to reservation of one of the lower cars 7 of the plurality of elevators 1. The processing in the step S103 corresponds to the function F3.

In the step S102, the control unit 31 has identified a time when the lower car 7 of the elevator 1 has no reservation. Thus, in the step S103, the control unit 31 identifies and reserves the lower car 7 of the elevator 1 that can be reserved at that time.

Next, after reserving the elevator 1, the control unit 31 reserves the vehicle V1 that transports the cargo based on reservation information of the reserved cargo handling space 10 (the step S104). The processing in the step S104 corresponds to the function F4.

In the step S104, the control unit 31 extracts the parking space number and the parking space reservation time included in the reservation information 45 of the parking space 30 stored in the first database 33. Further, in this step, among the vehicles V1 preregistered in a storage device (not shown) of the server 3, the control unit 31 identifies the vehicle V1 that can be dispatched at the time at which the section 300 of the parking space 30 has been reserved, and reserves this vehicle V1.

At this time, the control unit 31 may reserve the vehicle V1 having a function suitable for transportation of the cargo based on the cargo type in the cargo information 47. The number of reserved vehicles V1 is appropriately changed according to the cargo information 47.

The vehicle V1 that transports the cargo is thereby determined. That is, entry of the vehicle V1 into the cargo handling space 10 and reservation of loading cargo onto the vehicle V1 are determined. After the reservation of the vehicle V1, the control unit 31 may further determine an expected arrival time of the vehicle V1 at the cargo handling space 10.

Next, the control unit 31 stores the reservation information resulting from the steps S101 to S104 in the first database 33. This process determines the cargo space number where cargo is held, the reserved time of the cargo space 20, the parking space number, the reserved time of the parking space 30, the vehicle number, the car number, the car type, the reserved time of the elevator 1, and the like.

Further, the control unit 31 assigns a reservation number to the reservation information resulting from the steps S101 to S104 and updates the reservation information. For example, a tenant employee can call up the information stored in the first database 33 by using that reservation number.

The control unit 31 may further output the reservation information reserved in the first database 33 to the tenant terminal 81. This allows the employee to confirm that the cargo handling space 10, the elevator 1, and the vehicle V1 have been reserved. The reservation processing by the control unit 31 is thus completed. Further, reservation for cargo unloading from the tenant is completed as well.

When any of the cargo handling space 10, the elevator 1, and the vehicle V1 cannot be reserved in the steps S101 to S104, the control unit 31 may output that information to the tenant terminal 81.

This allows the employee to retry reservation of the cargo handling space 10 or the like. When reservation cannot be made at a desired time of the user, the control unit 31 may output candidates of reservable times different from the desired time to the tenant terminal 81.

### [Processing on Date and Time for Which Reservation Has Been Made]

The vehicle V1 reserved in the step S104 arrives at the cargo handling space 10. The section 300 of the parking space 30 where the vehicle V1 parks has been reserved. This facilitates entry of the vehicle V1 into the parking space 30 and parking of the vehicle V1. When the vehicle V1 arrives, for example, the manager of the cargo handling space 10 inputs arrival information of the vehicle V1 by operating the cargo handling space terminal 83.

This allows the control unit 31 of the server 3 to acquire the arrival information of the vehicle V1 from the cargo handling space terminal 83 (the step S201). The processing in the step S201 corresponds to the function F5. At this time, the control unit 31 may add the arrival time at which the vehicle V1 arrived at the parking space 30 to the reservation information.

The arrival information of the vehicle V1 may be input by a driver of the vehicle V1 operating the cargo handling space terminal 83 or the vehicle terminal 85. Alternatively, the control unit 31 may acquire the arrival information of the vehicle V1 by a sensor 87 installed in the cargo handling space 10 outputting to the control unit 31 a signal indicating detection of arrival of the vehicle V1.

The control unit 31 may also acquire the arrival information of the vehicle V1 by acquiring position information of a GPS mounted on the vehicle V1, expected arrival information of a car navigation system that reflects road congestion and the like.

At this time, the control unit 31 may calculate the expected arrival time of the vehicle V1 with higher accuracy based on the position information of the vehicle V1 while additionally reflecting a detailed congestion situation around the building BLD that cannot be fully grasped by the car navigation system. The control unit 31 can acquire information relating to the detailed congestion situation from, for example, surveillance cameras installed in the building BLD and drive recorders installed in the vehicle V1, which are communicably connected through the network N.

After calculating the expected arrival time, the control unit 31 may determine whether the expected arrival time of the vehicle V1 needs adjustment. For example, the control unit 31 compares the calculated expected arrival time with the expected arrival time determined in the step S104. The control unit 31 determines that adjustment is necessary when the deviation is equal to or greater than a predetermined time (for example ten minutes).

After the adjustment, the control unit 31 outputs information associated with the adjustment to the vehicle terminal 85 or the like. The information associated with the adjustment is an instruction to hold at an appropriate place near the building BLD when the adjusted expected arrival time is earlier than the expected arrival time determined in the step S104. Further, the information associated with the adjustment is an instruction to delay the expected arrival time when the adjusted expected arrival time is later than the expected arrival time determined in the step S104. The information associated with the adjustment is not limited to these examples.

In response to arrival of the vehicle V1, the control unit 31 may also acquire an entry request for the parking space 30 from the vehicle V1 (for example, the vehicle terminal 85) and may output information indicating permission of the entry to the vehicle V1 (for example, the vehicle terminal 85) in response to the acquired request.

Next, the control unit 31 controls the elevator 1 based on the reservation information 41 of the reserved elevator 1 (the step S202). The processing in the step S202 corresponds to the function F6. Specifically, the control unit 31 extracts a car number, an elevator reservation time, and a floor included in reservation information for the elevator 1 stored in the first database 33 and controls the elevator 1.

For example, the control unit 31 controls the elevator 1 such that the lower car 7 of the elevator 1 moves to a floor from which the cargo is unloaded based on the elevator reservation time. This configuration facilitates the loading of cargo from the tenant into the lower car 7 of the elevator 1. Further, this allows the employee to transport the cargo transported by the elevator 1 to the reserved section 200 of the cargo space 20 and hold the cargo there.

For example, when the cargo is an article requiring special care during transport, a long waiting period of the cargo at the boarding/alighting place FL or the like is not preferable. Thus, control of the elevator 1 based on the reservation information 41 of the elevator 1 can shorten the waiting time.

In the cargo space 20, cargo to be unloaded is held in the reserved section 200. Thus, when the driver of the vehicle V1 arrives at the parking space 30, the driver can immediately load the cargo onto the vehicle V1.

As described above, the management system 100 can facilitate entry and parking of the vehicle V1 in the section 300 of the parking space 30, unloading of cargo from the tenant, holding in the section 200 of the cargo space 20, and transport of the cargo from the section 200 of the cargo space 20 to the vehicle V1.

The order of the processing in the steps S201 and S202 may be changed as appropriate based on the reserved time of the elevator 1, the arrival time of the vehicle V1, and the reserved time of the cargo space 20. In one example, the control unit 31 controls the elevator 1 based on the arrival information. Specifically, the control unit 31 starts control of the elevator 1 after acquisition of the arrival information of the elevator 1. Alternatively, the control unit 31 may control the elevator 1 based on the reserved time of the elevator 1 without acquiring the arrival information.

On completion of loading of cargo to the vehicle V1, the vehicle V1 departs from the cargo handling space 10. On the departure of the vehicle V1, for example, a manager of the cargo handling space 10 operates the cargo handling space terminal 83 and inputs work completion information. The control unit 31 thereby acquires the work completion information from the cargo handling space terminal 83 (the step S203). The processing in the step S203 corresponds to the function F7.

Alternatively, the work completion information may be input by the driver of the vehicle V1 through operation of the cargo handling space terminal 83 or the vehicle terminal 85. Alternatively, the control unit 31 may acquire the work completion information by the sensor 87 installed in the cargo handling space 10 outputting to the control unit 31 a signal indicating detection of departure of the vehicle V1.

Next, based on the completion information, the control unit 31 sets a flag indicating work completion on a flag of the reservation information and updates the reservation information. At this time, the control unit 31 may add the completion time at which cargo handling was completed to the reservation information. The control unit 31 may further output the work completion information to the tenant terminal 81. This allows the employee to confirm the completion of the work. The processing on the date and time for which a reservation has been made (the work completion processing) by the control unit 31 is thus completed. Further, unloading of cargo from the tenant is completed.

In some cases, trouble may occur in the building BLD and cargo handling may become temporarily impossible or the work cannot proceed as scheduled. In those cases, the control unit 31 may acquire information on such situations and output the information to the vehicle terminal 85 before arrival of the vehicle V1.

Examples of the trouble include a contact accident of vehicles in the cargo handling space 10 requiring handling of the accident, a fire in the building BLD, or a delay in scheduled work due to malfunction of the elevator 1 or a transport vehicle described later in the building BLD.

This configuration can avoid a situation where the vehicle V1 that has come close to the building BLD cannot enter the parking space 30 and remain near the building BLD. This allows the driver of the vehicle V1 to prioritize transport of cargo other than the cargo to be transported to the building BLD.

In cargo handling in the building BLD, cargo is transported between the elevator 1 and the vehicle V1 through the cargo handling space 10. The cargo is transported by the lower car 7 of the elevator 1. In contrast, the upper car 6 transports general users.

Thus, in cargo transport by the elevator 1, a congested time of the elevator 1 caused by general users and a reserved time of the elevator 1 are preferably avoided.

The management system 100 reserves the cargo handling space 10 and the elevator 1 based on the congestion information. Specifically, the control unit 31 reserves the cargo handling space 10 and the elevator 1 considering congestion of general users, based on the reservation information stored in the first database 33 and the information stored in the second database 35, for example a congested time of general users transported by the upper car 6.

That is, the management system 100 manages the elevator 1 and the cargo handling space 10 while separately considering states of different objects (general users and cargo). Reservation of the elevator 1 based on the congestion information of the elevator 1 allows cargo transport to avoid a congested time of the elevator 1. From the viewpoint of general users, use of the upper car 6 is also less likely to be hindered by cargo transport. The management system 100 can suppress cargo transport using the lower car 7 according to the congestion information.

The management system 100 also facilitates cargo handling in the building BLD and maintenance of cargo handling service quality without installation of a dedicated elevator shaft for a cargo-handling elevator.

The above has described the reservation processing and processing on a date and time for which a reservation has been made in the management system 100 on the assumption of cargo unloading from a tenant. In cargo loading to a tenant as well, processes of the steps S101 to S104 and S201 to S203 are performed in the same manner as in unloading.

The following will describe an example in which reservation is made by using a terminal such as a computer (not shown) installed in an office of a transportation company or the like and communicably connected to the server 3 through the network N. The terminal used for reservation may instead be the tenant terminal 81 or the vehicle terminal 85.

For example, in the step S101, an employee of the transportation company operates the terminal and inputs the cargo information 47 of cargo to be loaded. The control unit 31 of the server 3 acquires the cargo information 47 from the terminal (the step S101). Next, in the step S102, the control unit 31 performs the following processes.

When the control unit 31 acquires the cargo information 47, the control unit 31 identifies a reservable section 200 of the cargo space 20 based on the congestion information of the elevator 1. The control unit 31 outputs a reservable time of the identified section 200 to the user terminal.

After the employee selects the desired time, the control unit 31 acquires information of the selected time from the terminal. In this manner, the control unit 31 thereby reserves the section 200 of the cargo space 20 where cargo is held at the selected time.

Next, based on the time at which the section 200 of the cargo space 20 has been reserved, the control unit 31 identifies and reserves a reservable section 300 of the parking space 30. For example, the time to be reserved here is a time former than (before) the time at which the cargo space 20 has been reserved. The time at which the section 300 of the parking space 30 is reserved may instead include, for example, the time at which the cargo space 20 has been reserved.

Next, the control unit 31 reserves the elevator 1 based on the congestion information of the elevator 1 (the step S103). Next, after reserving the elevator 1, the control unit 31 reserves the vehicle V1 that transports the cargo based on reservation information of the cargo handling space 10 reserved in the step S102 (the step S104).

Next, the control unit 31 stores the reservation information resulting from the steps S101 to S104 in the first database 33. Further, the management system 100 assigns a reservation number to the reservation information resulting from the steps S101 to S104 and updates the reservation information.

On the date and time for which the reservation has been made, the section 300 of the parking space 30 where the vehicle V1 parks has been reserved. This facilitates the entrance of the vehicle V1 to the parking space 30 and enables immediate parking. Further, this allows the driver to transport the cargo from the vehicle V1 to the reserved section 200 of the cargo space 20 and hold the cargo there.

The control unit 31 controls the elevator 1 based on the reservation information 41 of the reserved elevator 1 (the step S202). Specifically, based on the elevator reservation time, the control unit 31 controls the elevator 1 such that the lower car 7 of the elevator 1 moves to the basement floor B2 where the cargo handling space 10 is present. This control facilitates loading of cargo from the cargo space 20 into the reserved elevator 1 and loading of cargo to a tenant.

The management system 100 facilitates entry and parking of the vehicle V1 in the section 300 of the parking space 30, transporting from the vehicle V1 to the section 200 of the cargo space 20, holding in the section 200 of the cargo space 20, and loading of the cargo to the tenant.

The management system 100 configured as described above can improve convenience for users of the building BLD. Specifically, the management system 100 can reliably secure the elevator 1, the cargo space 20, the parking space 30, and the vehicle V1 during unloading and loading of cargo.

This configuration can suppress or avoid forced carrying of cargo into the cargo handling space 10, congestion of the cargo handling space 10, prolonged stagnation of cargo in the cargo handling space 10, and prolonged waiting of users of the elevator 1 or the parking space 30.

As a result, this configuration can suppress, for example, traffic congestion of the vehicles V1 waiting for the parking space 30 and stopping or parking of vehicles V1 on roads, and can achieve shortening of occupancy time of the parking space 30 and elimination of shortages of the cargo space 20 and the parking space 30.

Elimination of a shortage of the parking space 30 results in, exhibiting the same cargo handling function with the area smaller than the area required for a building to which the management system 100 is not applied, at the stage of planning the building.

Manual arrangement of management of the elevator 1, the cargo handling space 10, and the vehicle V1 is extremely complicated. The management system 100 according to the present embodiment can collectively manage the elevator 1, the cargo handling space 10, and the vehicle V1 based on the congestion information. This configuration can reduce, for example, workload of the manager of the cargo handling space 10.

The management system 100 according to the present embodiment can effectively use one elevator shaft 4 by installing a plurality of cars (the upper car 6 and the lower car 7) that transport different objects in the one elevator shaft 4. That is, the configuration can enable effective space use of the elevator 1 in the building BLD.

Further, the management system 100 according to the present embodiment requires no dedicated elevator shaft for a cargo-handling elevator, reducing the number of the elevators 1 installed in the building BLD. Thus, the management system 100 can reduce the area occupied by the elevator shaft 4 on each floor. This results in increasing the degree of freedom in planning of each floor and the entire building BLD.

From another viewpoint, the management system 100 according to the present embodiment eliminates a need, from the design stage of the building BLD, to secure an unnecessarily large floor area for the cargo handling space 10 and the surrounding area.

The management system 100 according to the present embodiment can also be applied to an existing building BLD. For example, in the floor area of the cargo handling space 10 of an existing building BLD, the management system 100 can handle cargo handling of more cargo than before application of the management system 100.

A cargo handling space 10 that is originally intended only for cargo handling of an existing building BLD may also be used as a shared cargo handling space including nearby buildings. This may increase cargo handling volume. Even in that case, the management system 100 according to the present embodiment can improve cargo handling capacity of the cargo handling space 10 and can satisfy new cargo handling demand.

The management system 100 according to the present embodiment can satisfy, for example, rapid spread of same-day delivery and next-day delivery and can also contribute to realization and practical use of autonomous vehicles expected in the near future. As described above, the present embodiment can provide the management system 100 capable of improving convenience for users of the building BLD. Various preferable effects can also be obtained from the present embodiment in addition to those described above.

FIG. 1 discloses the example in which the cargo handling space 10 is on the basement floor B2. Alternatively, the second cargo handling space may be provided on an intermediate floor.

Specifically, when a theater or the like is provided on lower floors (for example the first to fifth floors), a person going to an office uses an elevator that goes directly to a transfer floor, called an office entrance, located on the sixth floor or higher, and does not stop at the floor where the theater is located. Thus, an elevator having high transport capacity and a large passenger capacity is installed from the building entrance on the above-ground floor to the transfer floor.

Such a case requires cargo transfer between the lower car of the elevator going up to the transfer floor and the lower car of an elevator going above the transfer floor. Thus, for example, the second cargo handling space is provided on an intermediate floor (for example the transfer floor).

Even in such a case, the management system 100 according to the present embodiment can fully exhibit its function by appropriately managing the congestion information and the reservation information of the transfer floor.

When the building BLD is a high-rise building having a seismic isolation structure, the seismic isolation structure may be provided on an intermediate floor. The elevator 1 penetrates (passes through) the intermediate floor having the seismic isolation structure. Thus, a transfer floor also needs to be provided in the high-rise building having the seismic isolation structure. The present embodiment can handle such a case by providing the second cargo handling space immediately below the transfer floor or the like.

The present embodiment discloses the example in which the control unit 31 of the server 3 comprises the functions F1 to F7. Alternatively, the management system 100 may be configured as a plurality of devices (systems) capable of realizing at least one of the functions F1 to F7. The management system 100 may include a system of a transportation company.

The system of the transportation company is, for example, a system for managing a transportation business using a plurality of vehicles in the transportation company. The system of the transportation company is constituted by a computer including a processor such as a CPU, a storage device such as a ROM and a RAM, and an interface with the outside.

The system of the transportation company may include the vehicle terminal 85. When the vehicle V1 is reserved by the system of the transportation company, reservation is confirmed by the acquisition of the information reserved by the system of the transportation company by the control unit 31.

The step S101 discloses an example in which the cargo information 47 is input from the tenant terminal 81 and the vehicle terminal 85. The cargo information 47 may instead be input from another system (not shown).

Reservation processing for the elevator 1, the cargo handling space 10, and the vehicle V1 in the management system 100 is not limited to the example described above. The management system 100 may further comprise other functions. The following will describe an example in which the control unit 31 of the server 3 achieves each function in the management system 100.

[F8] A function of providing information relating to reservation to a user based on the congestion information

For example, in the step S102 described above, the control unit 31 acquires the cargo information 47 and then identifies information relating to reservation based on the congestion information and outputs the information to a user terminal. The control unit 31 outputs the information to the user terminal together with, for example, the reservable time described above. The processing in the step S102 includes the processing corresponding to the function F8. The user terminal may be the tenant terminal 81, the cargo handling space terminal 83, or the vehicle terminal 85.

The information relating to reservation is used for energy saving and for avoiding congestion. The information relating to reservation is, for example, information indicating at what point in time loading of cargo is possible, at what point in time waste can be unloaded, or during what time period a truck can be held parked without problem.

In another example, the information relating to reservation is information predicting whether the cargo handling space 10 or traffic around the building BLD will become congested in the future after input of the cargo information 47. The above information relating to reservation corresponds to an example of recommended information provided to a user.

For example, the control unit 31 appropriately extracts the cargo space number included in the reservation information 43 of the cargo space 20 and the cargo space reservation time of the cargo space 20 each stored in the first database 33, a peak time of general users included in the congestion information, a moving time included in information relating to moving, information relating to weather, and an event time included in information relating to an event each stored in the second database 35, and identifies information relating to reservation.

[F9] A function of calculating a fee required for transport of cargo based on information relating to fees

The information relating to fees relates to fees associated with use of facilities relating to cargo handling, such as the section 200 of the cargo space 20 and the section 300 of the parking space 30. The fee varies according to, for example, time, day of the week, season, and presence or absence of an event.

The information relating to fees may be stored in the second database 35 or may be stored in a storage device communicably connected through the network N. For example, the fee is collected from the tenant by the owner side of the building BLD.

For example, in the step S102 described above, the control unit 31 acquires the cargo information 47 and then identifies a reservable time of the section 200 based on the congestion information and the information relating to fees and calculates a fee required for transport of the cargo according to the reservable time. The processing in the step S102 includes the processing corresponding to the function F9. The fee required for transport of the cargo is, for example, a fee of the section 200 of the cargo space 20 according to the reserved time, a fee of the section 300 of the parking space 30, or a total of those fees. The following will describe an example in which the processing corresponding to the function F9 is performed in the step S102. Alternatively, the processing corresponding to the function F9 may be performed in other steps.

For example, together with the identified reservable time of the section 200, the control unit 31 outputs information created in a predetermined pattern based on the calculated fee to the user terminal. The predetermined pattern is created based on a difference in fee and a difference in a possible loading time and possible unloading time.

More specifically, the predetermined pattern is, for example, a pattern having the lowest cost or a pattern allowing the earliest cargo transport. The user terminal may be the tenant terminal 81, the cargo handling space terminal 83, or the vehicle terminal 85.

This configuration allows the user to grasp, for example, during which time period the fee is low or high. That is, the range of choices widens for the user, such as whether to prioritize time or fee at the time of reservation. The fee calculated by the control unit described above is an example of recommended information provided to the user.

In another example, the control unit 31 may identify a time period where use of the lower car 7 is recommended. The control unit 31 may output, to the user terminal, information indicating that a usage fee becomes lower when the recommended time period is selected. Further, the control unit 31 may additionally output, to the user terminal, information relating to a benefit (granting of points to a tenant) when the recommended time period is followed.

When a fee is generated by use of a facility such as the cargo handling space 10 in this manner, the control unit 31 may notify the user side or a payment management company of the charging information or may cumulatively add the fee until an appropriate timing and may output the accumulated fee to a user terminal or the like at the time of monthly settlement.

[F10] A function of adjusting reservations to collectively transport a plurality of pieces of cargo, based on a plurality of pieces of the cargo information 47

Adjusting reservations includes adjusting reservations of the elevator 1, the cargo handling space 10, and the vehicle V1 to collectively perform cargo handling of a plurality of pieces of cargo.

For example, the control unit 31 extracts a type, a quantity, and a size of cargo included in a plurality of pieces of the cargo information 47, gathers cargo that can be collectively transported into a predetermined section 200, and manages the gathered cargo such that the cargo does not exceed a predetermined amount for the section 200. For example, the predetermined amount is a quantity of cargo that can be held in the section 200 and a total mass of cargo that can be held in the section 200, which are stored in advance in the server 3 as one of pieces of information relating to the cargo space 20.

When the cargo gathered in the section 200 of the cargo space 20 reaches the predetermined amount, the control unit 31 reserves the elevator 1 and the vehicle V1 such that unloading by the vehicle V1 or loading into a tenant is performed.

In another example, the predetermined amount may be an upper loading limit of the vehicle V1 that collects waste at a fixed date and time in unloading of general waste such as combustible material. In this case, the control unit 31 may reserve the elevator 1 used by each tenant for unloading waste to accumulate the waste in the section 200 of the cargo space 20 (for example a section dedicated to waste).

Reservation adjustment may be performed in the step S102 based on a plurality of pieces of the cargo information 47 stored in the first database 33, or may be performed at a predetermined timing.

Collective cargo handling of a plurality of pieces of cargo shortens occupancy time of the parking space 30 and facilitates securing of vacant time of the section 300, as compared with a case where the section 300 of the parking space 30 is reserved every time the cargo information 47 is acquired.

At the timing of cargo pickup, the control unit 31 may reserve the cargo handling space 10, the elevator 1, and the vehicle V1 such that cargo is gathered in a predetermined section 200 of the cargo space 20. For example, the gathered cargo is objects transported regularly.

In this case, the processing corresponding to the function F10 by the control unit 31 performs the processes of the steps S101 to S104 at a predetermined timing. That is, the control unit 31 creates a cargo handling schedule.

Loading and unloading of cargo by each tenant according to the created schedule facilitates cargo handling in the building BLD. For example, when the cargo is objects transported regularly, input work of the cargo information 47 can be omitted for each loading and unloading operation.

For example, a waste disposal company, a supplier and a laundry operator of objects for an accommodation facility come to pick up cargo regularly at a fixed time on a fixed day of the week. Thus, the control unit 31 may create a schedule for unloading cargo from the building BLD such that the cargo is gathered in the section 200 of the cargo space 20 by the timing of pickup.

In another example, the management system 100 may adjust an elevator load according to cargo transported by the lower car 7. The elevator 1 is provided with a counterweight (not shown). The counterweight moves in the elevator shaft 4 in the direction opposite to the elevator 1. For example, the counterweight is set according to approximately half of the total of the car weight and the upper load limit of the elevator.

For example, during a commuting time, an ascending elevator 1 heading to an office floor is almost full, while a descending elevator 1 may carry few passengers. Even the elevator 1 having no passengers consumes energy to lift the counterweight in its descending operation. In contrast, during an evening peak period in which the descending elevator 1 is congested, the ascending elevator 1 may have few passengers.

The control unit 31 may use the lower car 7 of the descending elevator 1 during the commuting time for unloading cargo. Specifically, in cargo unloading, the control unit 31 may identify a reservable time of the elevator 1, for example, from the commuting time.

In this case, the control unit 31 may appropriately adjust a cargo load to be unloaded according to the counterweight. This suppresses the energy consumption of a motor of the elevator 1. Similarly, the control unit 31 may use the lower car 7 of the ascending elevator 1 during the evening peak period for loading cargo.

As described above, the management system 100 uses the lower car 7 in cargo transport to achieve energy saving in the entire building BLD. Cargo transported here is cargo that can be held for a timing of unloading and loading.

For example, in the step S103, when a time period enabling energy saving exists in elevator operation, the control unit 31 may output, to a user terminal (for example the tenant terminal 81), a recommended time period for contributing to energy saving. The time period enabling energy saving corresponds to an example of the recommended information (the information relating to reservation) provided to the user.

In the elevator 1, the object of the lower car 7 is not limited to cargo. The lower car 7 may transport a user other than a general user. Examples of the user other than a general user include a VIP. In this case, the VIP corresponds to an example of an object transported by the elevator. The user other than a general user is not limited to a VIP.

In this case, the cargo handling space 10 corresponds to a space dedicated to VIPs, the cargo space 20 corresponds to a lounge dedicated to VIPs, the parking space 30 corresponds to a VIP-only drop-off area or a VIP-only parking space, and the vehicle V1 corresponds to a vehicle dedicated to VIPs.

The space dedicated to VIPs corresponds to an example of a waiting space. The space dedicated to VIPs may be provided on a floor different from that of the cargo handling space 10. The door 71 may be provided for the lower car 7 for VIPs such that the entrance position of the lower car 7 becomes the same as that of the upper car 6.

Alternatively, the door 71 of the lower car 7 for VIPs may be provided such that its entrance position differs from both the entrance position of the upper car 6 and the entrance position of the lower car 7 for cargo. At the boarding/alighting place FL of the lower car 7 for VIPs, a VIP-dedicated space may be provided on a specific floor.

Even when the lower car 7 transports a VIP, the management system 100 performs the processes of the steps S101 to S104 and S201 to S203. As reservation information, information relating to the VIP is stored instead of the cargo information 47.

The management system 100 eliminates a need to provide a dedicated elevator for VIPs or an elevator shaft for the dedicated elevator for VIPs in the building BLD even when a VIP is transported. Thus, the management system 100 can further reduce the area occupied by the elevator shaft 4 on each floor.

Prolonged waiting of the VIP at the boarding/alighting place FL of the elevator 1 or in the lounge, for example, during pickup and drop-off is not preferable. The management system 100 can facilitate arrival of the VIP at the building BLD, movement within the building BLD, and departure from the building BLD, and can avoid unnecessary waiting of the VIP.

The following will describe other embodiments. The following descriptions on the other embodiments may allocate the same reference number as those in the first embodiment described above to the components similar to those of the first embodiment and simplify or omit the detailed description on these corresponding components.

### Second Embodiment

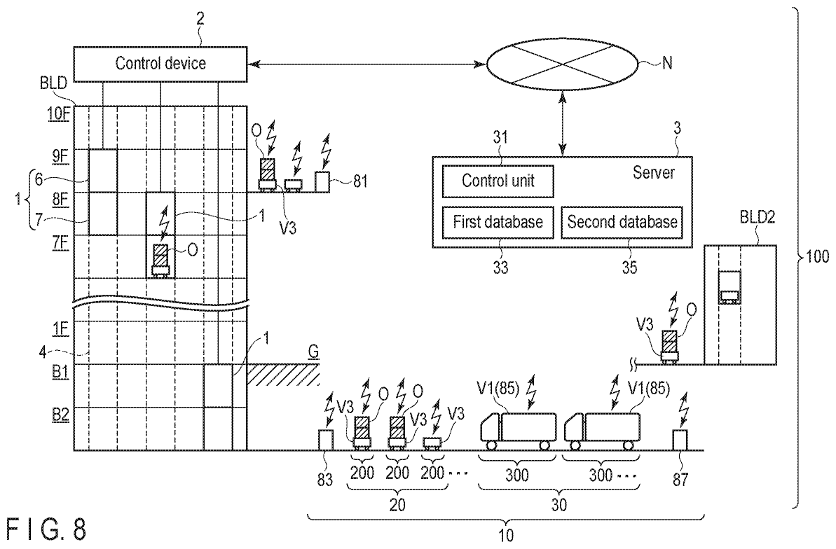

FIG. 8 is a diagram showing a configuration example of the management system 100 according to the present embodiment. The management system 100 may further manage a transport vehicle V3, which is an automatic transport vehicle. In the present embodiment, the transport vehicle V3 corresponds to an example of the second vehicle. The transport vehicle V3 is a vehicle capable of transporting cargo to a destination by autonomous travel. The transport vehicle V3 may adopt various mechanism. For example, the transport vehicle V3 uses a chargeable battery as a drive source. This example does not limit the configuration.

The transport vehicle V3 includes communication means capable of communicating with the server 3 through the network N. In one example, the transport vehicle V3 transports, inside the building BLD and between a tenant and the cargo handling space 10, cargo transported by the vehicle V1. Cargo transported by the vehicle V1 is cargo loaded into the building BLD, cargo unloaded from the building BLD, and the like.

For example, a plurality of transport vehicles V3 are provided in the building BLD. Information relating to the transport vehicle V3 and information relating to a route between a tenant and the cargo handling space 10 through which the transport vehicle V3 travels are stored in advance in a storage device (not shown) of the server 3.

Not only vehicles having the same characteristics (functions and performance), but also a plurality of types of transport vehicles V3 may be provided according to cargo characteristics. Examples of types of the transport vehicles V3 include a transport vehicle dedicated to waste and a transport vehicle having a refrigeration function for carrying food ingredients for a restaurant or a hotel.

The management system 100 according to the present embodiment further includes the following functions:

[F11] A function of reserving the transport vehicle V3 that transports cargo based on reservation information of the reserved cargo handling space 10; and

[F12] A function of controlling the transport vehicle V3 based on reservation information of the reserved transport vehicle V3.

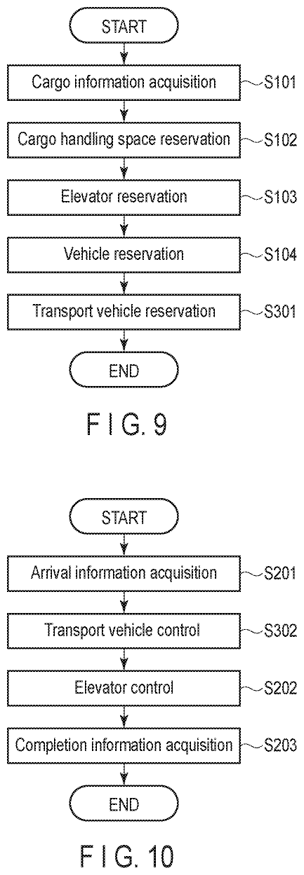

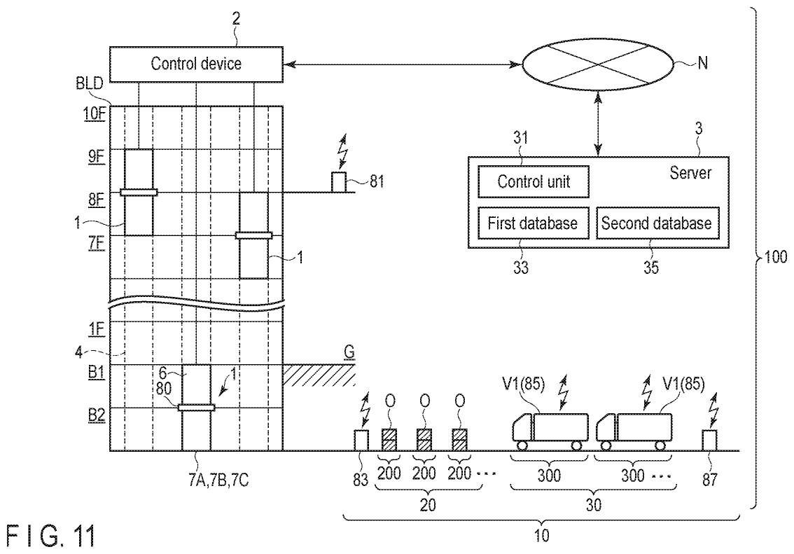

FIG. 9 and FIG. 10 are flowcharts showing an example of processing in the management system 100 according to the present embodiment. The following will describe an example in which the functions F11 and F12 are achieved by the control unit 31 of the server 3 using unloading of cargo from a tenant as an example.

The following will describe reservation of the transport vehicle V3 and the processing on a date and time for which a reservation has been made in the management system 100. The following will appropriately omit descriptions on steps performing the processes similar to those in the first embodiment.

After the step S104, the control unit 31 further reserves the transport vehicle V3 that transports cargo based on reservation information of the cargo handling space 10 reserved in the step S102 (the step S301). The processing in the step S301 corresponds to the function F11.

The control unit 31 extracts the cargo space number and the cargo space reservation time included in the reservation information 43 of the cargo space 20 stored in the first database 33. Further, among the transport vehicles V3 preregistered in a storage device (not shown) of the server 3, the control unit 31 identifies the transport vehicle V3 that can be dispatched and reserves this transport vehicle V3.

At this time, the control unit 31 may further extract the cargo type in the cargo information 47 and may reserve a transport vehicle V3 having a function suitable for transport of the cargo. The number of the reserved transport vehicles V3 is appropriately changed according to the cargo information 47. Thus, the transport vehicle V3 that transports the cargo is determined.

The control unit 31 may further determine a route between the tenant and the cargo handling space 10 through which the transport vehicle V3 travels. When the plurality of transport vehicles V3 are reserved, an order of the transport vehicles V3 may also be determined.

The reservation information stored in the first database 33 may further include a transport vehicle number, which is identification information for identifying the reserved transport vehicle V3, the number of transport vehicles V3, a reserved time of the transport vehicle V3, and a mass of the transport vehicle V3.

On the date and time for which a reservation has been made, the control unit 31 controls the transport vehicle V3 based on the reservation information of the reserved transport vehicle V3 (the step S302). The processing in the step S302 corresponds to the function F12. The order of the processing in the step S301 may be changed as appropriate based on the reserved time of the elevator 1, the arrival time of the vehicle V1, the reserved time of the cargo space 20, and the reserved time of the transport vehicle V3. In one example, the control unit 31 controls the transport vehicle V3 based on the arrival information. In another example, the control unit 31 may control the transport vehicle V3 based on at least one of the reserved time of the elevator 1 and the reserved time of the transport vehicle V3 without acquiring the arrival information.

Specifically, the control unit 31 extracts the transport vehicle number and the reserved time of the transport vehicle V3 included in the reservation information reserved in the first database 33 and controls the transport vehicle V3. This control allows the transport vehicle V3 to transport cargo from the tenant to the cargo handling space 10 based on the reservation information.

The elevator 1 is controlled by the control unit 31 based on the reservation information of the reserved elevator 1. The transport vehicle V3 can therefore facilitate transportation of the cargo from the tenant to the cargo handling space 10 through the elevator 1.

The transport vehicle V3 is held in the cargo space 20, for example, while carrying the cargo. The waiting transport vehicle V3 may further move to the vehicle V1 waiting in the parking space 30. This enables direct loading of cargo from the transport vehicle V3 onto the vehicle V1.

The above has described the transport vehicle V3 on the assumption of unloading of cargo from a tenant. In loading of cargo into a tenant as well, each process in the management system 100 is performed in the same manner as in unloading.

For example, during loading, the reserved transport vehicle V3 is held in the cargo space 20. When cargo is loaded onto the transport vehicle V3, the transport vehicle V3 transports the cargo to the tenant based on the reservation information.

The transport vehicle V3 can transport cargo between the tenant and the cargo handling space 10. Thus, the transport vehicle V3 can reduce the labor of a person who transports cargo between the tenant and the cargo handling space 10.

The transport vehicle V3 can also perform cargo transport without human attendance during late night hours where demand for the elevator 1 is low. Input of the cargo information 47 may also be performed from the tenant terminal 81 without human attendance. The control unit 31 may cause the transport vehicle V3 to be held on each floor based on the congestion information of the cargo handling space 10.

Alternatively, the transport vehicle V3 may transport cargo between the cargo handling space 10 and a nearby building BLD2 (shown in FIG. 8). The nearby building BLD2 corresponds to an example of a building different from the building BLD. In yet another example, the transport vehicle V3 may transport cargo between the tenant and the cargo handling space 10 and between the cargo handling space 10 and the nearby building BLD2. That is, the transport vehicle V3 may transport cargo between a plurality of buildings (two or more buildings).

In these cases, the transport vehicle V3 may transport cargo to a tenant of the nearby building BLD. Specifications of the transport vehicle V3 may differ between a case where the transport vehicle V3 travels only inside the building BLD and a case where the transport vehicle V3 travels outside the building BLD.

Further, the transport vehicle V3 carrying cargo from the tenant may enter the vehicle V1 as it is. The transport vehicle V3 carrying cargo may disembark from the vehicle V1 and may then transport the cargo to the tenant in that state.

The management system 100 according to the present embodiment further comprises the following functions. The following will describe an example in which the control unit 31 of the server 3 achieves each function in the management system 100.

[F13] A function of controlling the transport vehicle V3 based on the transport vehicle information

The transport vehicle information is information relating to status such as the operating state of the transport vehicle V3 and a battery charge state of the transport vehicle V3. The operating state includes the position of the transport vehicle V3, the cargo load carried by the transport vehicle V3, a type of cargo being transported, and the like. The charge state includes the remaining battery level, the remaining drivable time, and the like. The control unit 31 appropriately acquires the transport vehicle information from the transport vehicle V3 through the network N.

In the step S301, the control unit 31 may further extract the operating state included in the transport vehicle information to reserve the transport vehicle V3. The control unit 31 may extract the battery charge state of the transport vehicle included in the transport vehicle information and may determine whether the charging of the transport vehicle V3 is necessary.

According to the charge state (for example when the remaining charge is equal to or less than a predetermined amount), the control unit 31 may move the transport vehicle V3 to a predetermined position (for example, a charging place for the transport vehicle V3 provided in the building BLD) for charging or other maintenance. The processing corresponding to the function F13 for controlling the transport vehicle V3 for such maintenance may be performed in the steps S301 and S302 or may be performed at a predetermined timing.

[F14] A function of acquiring information on surroundings of the transport vehicle V3

[F15] A function of outputting the acquired information of the surroundings of the transport vehicle V3 to a user terminal

Examples of the information on surroundings of the transport vehicle V3 include images around the transport vehicle V3, temperature, and noise. From another viewpoint, the information on surroundings of the transport vehicle V3 includes an environment encountered by the cargo during transport. The acquired information on surroundings of the transport vehicle V3 is also information recording in what environment the cargo was placed during transport. The transport vehicle V3 may further include a camera for imaging the surroundings, a sensor for measuring surrounding temperature and noise, and the like. The surroundings of the transport vehicle V3 include not only the inside of the building BLD, but also the cargo handling space 10, the outside of the building BLD, and nearby buildings.

The control unit 31 may acquire, through the transport vehicle V3, information on surroundings such as a surrounding image captured by the camera and air temperature measured by the sensor. The control unit 31 stores these pieces of information in the storage device. Acquisition of information of the surroundings by the transport vehicle V3 (the processing corresponding to the function F14 by the control unit 31) may be performed at predetermined timings while the transport vehicle V3 is operating. Alternatively, the acquisition may be performed in real time.

The control unit 31 may output the acquired information of the surrounding of the transport vehicle V3 to the user terminal. The processing corresponding to the function F15 by the control unit 31 may be performed, for example, at predetermined timings while the transport vehicle V3 is operating. Alternatively, this processing may be performed in real time. This configuration allows the user to grasp air temperature, degree of pedestrian traffic, rain around the building BLD, possible snow accumulation or freezing on roads, and how congested the cargo handling space 10 is based on the information on surroundings.

Not only does the transport vehicle V3 perform the transport work without human attendance, but a user (for example, a monitor or security guard of the building BLD) can also check presence or absence of abnormality around the transport vehicle V3 by using the information on surroundings when necessary. The transport vehicle V3 is driven without human attendance and may therefore suffer damage such as destruction by passersby or theft of cargo. Recording of surrounding images and checking of the captured images by a user when necessary can achieve an effect of suppressing damage such as destruction by passersby and theft of cargo during transport.

### Third Embodiment

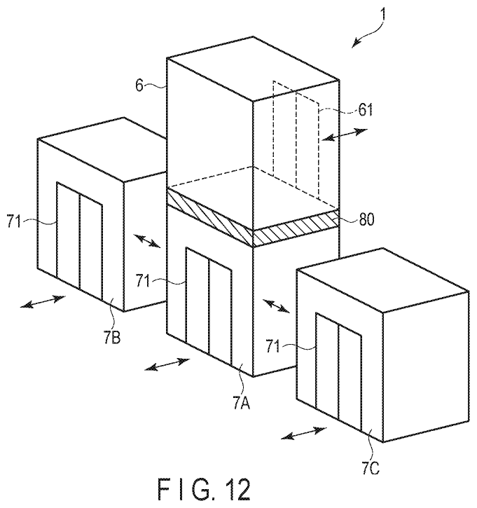

FIG. 11 is a diagram showing a configuration example of the management system 100 according to the present embodiment. FIG. 12 is a schematic perspective view of the elevator 1 shown in FIG. 11. The present embodiment differs from the first embodiment in that the elevator 1 is configured such that at least one of the upper car and the lower car is replaceable. The following will describe a case where the lower car is replaceable as one example.

The elevator 1 includes a coupling mechanism 80 that couples the upper car and the lower car. For example, the coupling mechanism 80 is configured such that the lower car can be exchanged with (attached to and detached from) another lower car. The coupling mechanism 80 may adopt various mechanisms. In one example, the coupling mechanism 80 is configured such that the lower car can be exchanged automatically.

In the building BLD, a plurality of lower cars is provided in advance according to objects to be transported. For example, the plurality of lower cars has functions adapted to transport objects having different characteristics. The plurality of lower cars includes a cargo car 7A, a VIP car 7B, and a waste car 7C. The interiors of the cars 7A, 7B, and 7C, structures of the doors, and the like are appropriately changed according to characteristics of the objects.

For example, the cargo car 7A may have a structure suitable for carts, pallets, and the like used in cargo transport, or may be made of a material having strong resistance to dirt and detergents for cleaning the dirt. For example, when no person rides in the waste car 7C, the waste car 7C may comprise a germicidal lamp that emits ultraviolet rays.

Even when the lower car is replaceable, the management system 100 performs the processes of the steps S101 to S104 and S201 to S203. For example, in the step S202, the control unit 31 determines whether exchange of the lower car is necessary based on the reservation information of the reserved elevator 1 and the cargo information 47. That is, the control unit 31 determines whether exchange of the lower car is necessary according to characteristics of the object.

When the type of the lower car matches the object, the control unit 31 determines that exchange of the lower car is unnecessary. When the type of the lower car does not match the object, the control unit 31 determines that exchange of the lower car is necessary. When exchange of the lower car is necessary, the control unit 31 exchanges the lower car of the elevator 1. The processing described above corresponds to an example of elevator control. The above has disclosed the example in which the lower car is replaceable. Alternatively, the upper car may be replaceable, or both of the upper car and the lower car may be replaceable.

The present embodiment can achieve the same effects as those of the first embodiment. Preparation in advance of a plurality of cars according to objects allows transporting a larger number of objects in one elevator shaft. Exchange of a car according to the object is sufficient. This facilitates the maintenance of the cars.

The type of lower car in the present embodiment is also not limited to the examples described above. Preparation of lower cars according to other specifications and appropriate exchange of the lower cars according to the object to be transported allow flexible response to transport of different objects.

In each embodiment, reservation of the elevator 1, the cargo handling space 10, and the vehicle V1 by the management system 100 does not restrict transport of an object requiring emergency response.

Each embodiment discloses an example in which the management system 100 manages the plurality of elevators 1, the plurality of sections 200 of the cargo space 20, and the plurality of sections 300 of the parking space 30. Alternatively, the management system 100 in each embodiment may manage one elevator 1, one section 200 of the cargo space 20, and one section 300 of the parking space 30.

Each embodiment discloses an example in which the elevator 1 is a double-deck elevator. Alternatively, the elevator may be a single-deck elevator or a multi-deck elevator. The management system 100 may be used to manage a cargo-handling elevator, a VIP elevator, and the like.

Each embodiment discloses the cargo handling space and the VIP-dedicated space as examples of the waiting space. These examples do not limit the waiting space. The waiting space may include a place on each floor at which an object is held and a place at which an object transported to each floor is held to be transported to a different tenant or delivery destination on the same floor. For example, in the step S102, the control unit 31 may reserve a waiting space for cargo in front of the boarding/alighting place FL of the elevator 1 on the tenant side of each floor of the building BLD.

In each embodiment, vertical floor heights (floor-to-floor heights) may differ among floors. In such a case, the upper car 6 and the lower car 7 do not simultaneously stop on any floor or open the doors to allow movement of cargo or passengers. For example, one of the upper car 6 and the lower car 7 may stop on a floor and open the door, while the other cannot open the door.

Each embodiment discloses the example in which the vehicle V1 and the transport vehicle V3 transport an object (for example, cargo or a VIP). This example does not limit the transport means for the object. Alternatively, the means for transporting the object (for example, cargo or a VIP) may be a means accessible from above the building BLD (for example a helicopter, a drone, or a flying taxi). The management system 100 may also manage such means. In this case, a facility corresponding to the cargo handling space in each embodiment may be provided, for example, on a rooftop of the building BLD or on a floor near the rooftop. For example, this configuration can facilitate cargo handling of cargo and pickup and drop-off of a VIP.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A management system for managing a waiting space for holding an object transported by an elevator, the management system comprising:
a first acquisition unit for acquiring object information relating to the object; and
a first reservation unit for reserving the waiting space for holding the object indicated by the object information based on congestion information of the elevator.

2. The management system of claim 1, further comprising:
a second reservation unit for reserving the elevator that transports the object indicated by the object information based on the congestion information; and
an elevator control unit for controlling the elevator based on reservation information for the elevator reserved by the second reservation unit.

3. The management system of claim 2, further comprising:
a third reservation unit for reserving a first vehicle that transports the object based on reservation information of the waiting space reserved by the first reservation unit.

4. The management system of claim 3, further comprising:
a second acquisition unit for acquiring arrival information of the first vehicle reserved by the third reservation unit, wherein
the elevator control unit controls the elevator based on the arrival information.

5. The management system of claim 2, wherein
the elevator includes an upper car and a lower car coupled to the upper car, and
the lower car transports the object different from the object transported by the upper car.

6. The management system of claim 5, wherein
the elevator is configured such that at least one of the upper car and the lower car is replaceable, and
the elevator control unit replaces the upper car or the lower car based on reservation information for the elevator and the object information.

7. The management system of claim 1, wherein
the first reservation unit identifies, based on the congestion information, a reservable time for the waiting space and outputs the reservable time to a user terminal.

8. The management system of claim 1, further comprising:
an adjustment unit for adjusting reservations to collectively transport the plurality of objects based on a plurality of pieces of the object information stored in a database.

9. The management system of claim 3, further comprising:
a fourth reservation unit for reserving a second vehicle different from the first vehicle based on reservation information of the waiting space reserved by the first reservation unit, wherein
the second vehicle transports the object transported by the first vehicle between the waiting space and an inside of a building where the waiting space is provided.

10. The management system of claim 9, further comprising:
a transport vehicle control unit for controlling the second vehicle based on reservation information of the second vehicle reserved by the fourth reservation unit.

11. The management system of claim 9, wherein
the second vehicle transports the object transported by the first vehicle between the waiting space and a building different from the building.

12. The management system of claim 9, further comprising:
a third acquisition unit for acquiring information on surroundings of the second vehicle.

13. The management system of claim 12, wherein
the third acquisition unit outputs the acquired information on surroundings of the second vehicle to a user terminal.

14. The management system of claim 1, wherein
the object information includes at least one of a quantity, a mass, a type, and a size of the object.

15. The management system of claim 2, wherein
the congestion information includes reservation information for the elevator reserved by the second reservation unit.

16. The management system of claim 15, wherein
the congestion information further includes at least one of information relating to a congestion time of the elevator, a calendar, weather, moving, construction work, and an event.

17. The management system of claim 3, wherein
reservation information of the waiting space includes at least one of identification information for identifying the waiting space and a reserved time of the waiting space reserved.

18. The management system of claim 2, wherein
reservation information for the elevator includes at least one of identification information for identifying a car included in the elevator, a type of a car included in the elevator, and a reserved time of the elevator.

19. The management system of claim 1, wherein
the object is at least one of cargo and a VIP.
